(19) United States
(12) Patent Application Publication
(10) Pub. No.: US 2003/0070069 A1
(43) Pub. Date: Apr. 10, 2003

(54) Authentication module for an enterprise access management system

(76) Inventors: Abhijit Belapurkar, Jersey City, NJ (US); Gayathri Krishnamurthy, Jersey City, NJ (US); Maneesh Bhandari, Edison, NJ (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/976,666

(22) Filed: Oct. 10, 2001

(51) Int. Cl. H04L 9/00; H04L 9/32; G06F 15/16

(52) U.S. Cl. 713/155; 713/201; 709/229

(57) ABSTRACT

A pluggable authentication module (PAM) is designed for compatibility with a receiver component. In response to a request for a protected web resource, the receiver component receives a user identification (user ID) from a secure and trusted source; the receiver component need not receive a password corresponding to the user ID. The receiver component generates and sends a login request to the PAM for authentication of the user. The login request contains a representation of the user ID, but is void of a corresponding user password. The receiver component and the PAM perform a trust establishment protocol that enables the PAM to determine whether the login request (and the received user ID) is legitimate.

### FIELD OF THE INVENTION

The present invention relates generally to enterprise access management (EAM) systems. More particularly, the present invention relates to a pluggable authentication module (PAM) that is compatible with known EAM systems,

### BACKGROUND OF THE INVENTION

Enterprise access management (EAM) systems are designed to securely manage end user access to web-based resources and applications. A number of EAM software products are currently available from different manufacturers. Most EAM products provide a framework for adding customized authentication protocols without affecting the core EAM software or its functionality. Such customization can be carried out by add-on software modules commonly known as pluggable authentication modules (PAMs).

The default authentication mechanism used by the majority of EAM systems requires both a user identification (ID) and a password. Consequently, an EAM system and/or a corresponding PAM must securely store the user ID and password for each legitimate end user. In addition, the passwords must be kept current and updated (because passwords may expire or change over time).

Conventional EAM systems, whether or not they utilize a PAM, prompt an end user to enter his user ID (or username) and password to gain access to a restricted web site (or to access restricted features of an unprotected web site). A protected web site may provide a link to access another restricted or protected web site or to access a restricted web resource. In some situations, the end user will be required to enter another user ID and another password to access the linked resource. In this regard, navigating between a number of restricted sites can be time consuming and frustrating.

Known solutions to the multiple authentication problem may be referred to as “single sign-on” techniques. In accordance with one known technique, a third party resource maintains a list of usernames and corresponding passwords for a number of different protected applications. Thus, after the user is initially authenticated, the third party resource can manage access to other restricted applications. Unfortunately, many users and organizations are hesitant to disclose confidential usernames and passwords to a third party (particularly when there exists a risk of unauthorized access to such information). Alternatively, each of the linked web sites can agree to merge security mechanisms, which results in a loss of autonomy and control by the individual sites. In reality, established organizations may be reluctant to change existing and proven security measures for the convenience of affiliated organizations.

In view of the shortcomings of conventional EAM systems and PAMs, particularly in connection with single sign-on issues, there exists a need for a technique that facilitates efficient end user authentication, thus allowing an end user to easily access a number of restricted web resources.

### BRIEF SUMMARY OF THE INVENTION

In accordance with the present invention, a PAM is configured to authenticate a user by processing a user ID without a corresponding password. The PAM receives the user ID in a login request from a receiver component, and the PAM determines whether the login request has been sent from a trusted source. When used in connection with an existing EAM system, the PAM facilitates efficient single sign-on procedures.

The above and other aspects of the present invention may be carried out in one form by a user authentication method that involves obtaining a user ID recognizable by an EAM system, generating a login request based upon the user ID, where the login request is void of a user password corresponding to the user ID, and evaluating the login request with a PAM compatible with the EAM system.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic block diagram of a data communication system;

FIG. 2 is a schematic block diagram of a receiver component;

FIG. 3 is a schematic block diagram of a PAM;

FIG. 4 is a schematic block diagram of an alternate PAM;

FIG. 5 is a flow diagram representing a single sign-on procedure;

FIG. 6 is a flow diagram representing a portion of a trust establishment protocol performed by a receiver component; and

FIG. 7 is a flow diagram representing a portion of a trust establishment protocol performed by a PAM.

### DETAILED DESCRIPTION OF A PREFERRED EMBODIMENT

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, processing elements, firmware elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application of the invention.

It should be appreciated that the particular implementations shown and described herein are illustrative of the invention and its best mode and are not intended to otherwise limit the scope of the invention in any way. Indeed, for the sake of brevity, conventional techniques related to HTTP, encryption and decryption, data transmission, signaling, web servers, web browsers, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

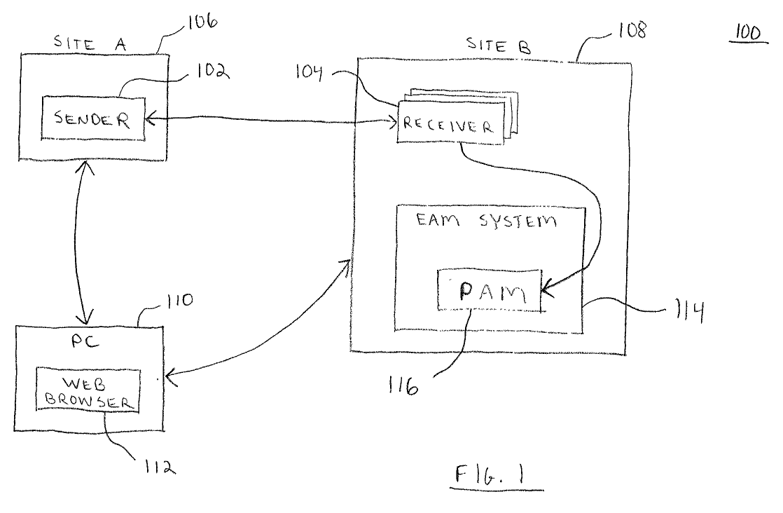

FIG. 1 is a schematic block diagram of a data communication system 100 including a sender component 102 and a receiver component 104. Generally, sender component 102 and receiver component 104 may each be realized as one or more hardware devices, one or more firmware devices, one or more software applications, or any combination thereof. For example, sender component 102 and receiver component 104 may each be realized in a personal computer (PC), a server computer, or any suitable processing element. In one practical embodiment, sender component 102 is associated with a first web site (referred to herein as Site A) 106, and receiver component 104 is associated with a second web site (referred to herein as Site B) 108. In such an embodiment, the sender and receiver components are implemented in the respective server computers that maintain the web sites.

In a practical Internet deployment where sender component 102 corresponds to Site A 106 and receiver component 104 corresponds to Site B 108, a user PC 110 is capable of communicating with sender component 102 and receiver component 104 via a network such as the Internet. In addition, sender component 102 and receiver component 104 are capable of communicating (directly or indirectly) with each other using the network. PC 110 may include a suitable web browser application 112 that allows the user to navigate web sites, redirects traffic between web sites, and otherwise functions in a conventional manner. In accordance with conventional HTTP techniques, PC 110 is capable of redirecting HTTP traffic from sender component 102 to receiver component 104, and vice versa. In this regard, sender component 102 need not directly communicate with receiver component 104.

Site B 108 utilizes an enterprise access management (EAM) system 114 that functions to securely manage end user access to web-based resources and applications maintained by Site B 108 or otherwise made available through Site B 108. EAM system 114 may also provide additional features such as user entitlement management and access rights management. In this regard, EAM system 114 may support typical functions included in conventional EAM systems, such as: securing content; managing users, entitlements, and granular access control reliably and cost effectively; customizing the user experience; scaling for large and small numbers of users and handing data traffic; integrating existing systems together with new web-based method of doing business; and providing a seamless integration between portal and affiliate web sites.

In a practical deployment, EAM system 114 can protect a plurality of applications, application groups, and/or web resources maintained by or otherwise associated with Site B 108. In the example embodiment described herein, one protected application (or group of applications) is associated with receiver 104, and other applications or application groups are respectively associated with a number of additional receivers. The present invention is suitable for use with commercially available EAM products, e.g., SITEMINDER from Netegrity, Inc., GETACCESS from Entrust, Inc., POLICY DIRECTOR from IBM Corp., and CLEARTRUST from RSA Security, Inc. In the example embodiment described herein, any of these (and other) existing products can be used for EAM system 114.

Most commercially available EAM products are designed to accommodate customized authentication techniques that do not affect the core EAM software or its functionality. In this regard, EAM system 114 includes (or cooperates and communicates with) a pluggable authentication module (PAM) 116. Although FIG. 1 depicts PAM 116 as a distinct component within EAM system 114, conceptually PAM 116 can be considered to be an integral part of EAM system 114. PAM 116, which is realized as a software processing module that is compatible with EAM system 114, is configured to receive a login request (including authentication data representing an end user) from receiver 104. In a practical embodiment, PAM 116 obtains the login request indirectly from receiver 104 via EAM system 114. Accordingly, for purposes of this description, PAM 116 may “receive” items directly from receiver 104 or indirectly via EAM system 114. For example, EAM system 114 may handle the login request using default mechanisms, or it can instruct PAM 116 to process the login request on its behalf. The particular mechanism for registering a PAM with an EAM product, as well as the mechanism by which the receiver can send login requests to the EAM system marked as intended for the PAM, is specific to each commercially available EAM product. Such mechanisms, which are beyond the scope of this description, are well documented and are available with the EAM products.

PAM 116 processes the login request to authenticate the user. In addition, PAM 116 communicates the authentication results to EAM system 114, which may perform any number of access management actions in response to the PAM activity. In practice, PAM 116 is specifically designed for compatibility with the particular EAM product used by system 100, and commercially available EAM products need not be modified to accommodate the techniques of the present invention.

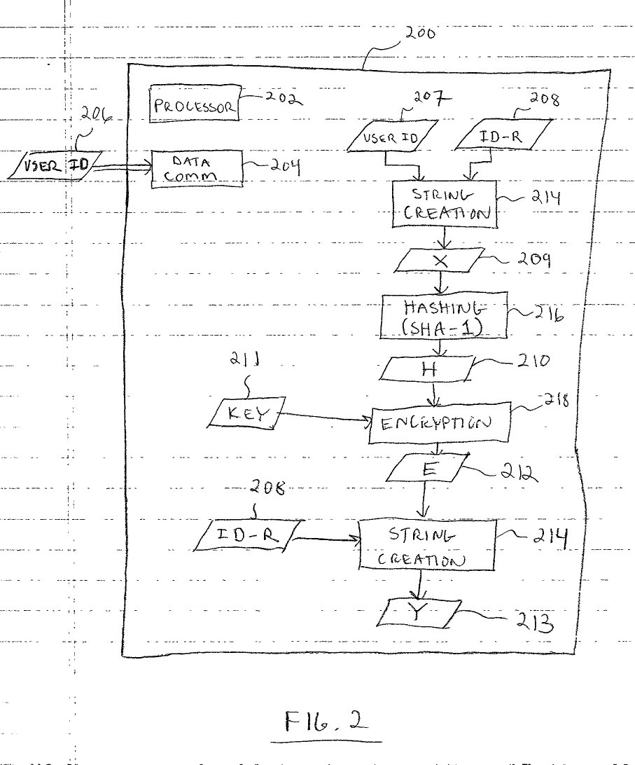

FIG. 2 is a schematic block diagram of an example receiver component 200 suitable for use in data communication system 100. In a typical deployment, receiver component 200 is realized at the respective web site host, e.g., the server (or servers) that maintains Site B 108. FIG. 2 illustrates certain data elements and functional features of receiver component 200 to aid in the following description of a trust establishment protocol carried out between the receiver component 200 and a PAM. Data elements may be stored in and retrieved from any suitable memory element (not shown) such as a magnetic disk, a ROM, or the like. In a practical deployment, the data elements can be stored in and retrieved from memory elements associated with the web site host and/or “remote” memory elements with which the web site host communicates. Functional elements shown in FIG. 2 may be realized in any number of computer program instructions, in firmware, in hardware, or in any combination thereof.

Receiver component 200 generally includes a processor 202 and a data communication element 204. Processor 202 is suitably configured to carry out the techniques, protocols, and software instructions described herein. Data communication element 204, which may include hardware, firmware, and/or software, facilitates the exchange of data, signals, packets, and information between receiver component 200 and other components in system 100, e.g., sender component 102, PC 110, EAM system 114, and/or PAM 116. In the example system described herein, data communication element 204 receives a user ID 206 from sender component 102.

As described in more detail below, receiver component 200 may receive, generate, store, retrieve, process, or send the following (and possibly other) items in connection with the trust establishment protocol: user ID 206, a user ID 207 (user ID 207 may be identical to user ID 206 or it may be a different parameter that is mapped to (or otherwise associated with) user ID 206), a receiver identifier 208, a string 209, a hash 210, a shared secret key 211, an encrypted expression 212, and a string 213. Receiver component 200 performs string creation 214 to form various strings utilized by receiver component 200, performs hashing operations 216 on data, and performs encryption 218 (using an encryption algorithm and secret key 211) to generate encrypted expression 212. It should be appreciated that the string creation function 214, the hashing function 216, and the encryption function 218 may each be implemented in software, hardware, firmware, or a combination thereof, and each can be executed or controlled by processor 202 or by any suitable processing element associated with receiver component 200. Accordingly, receiver component 200 may include a suitably configured string creator that performs the string creation function 214, a suitably configured hashing element that performs the hashing function 216, and a suitably configured encryptor that performs the encryption function 218. The relevance of these items and features, their characteristics, and the manner in which receiver component 200 interacts with the PAM are discussed below.

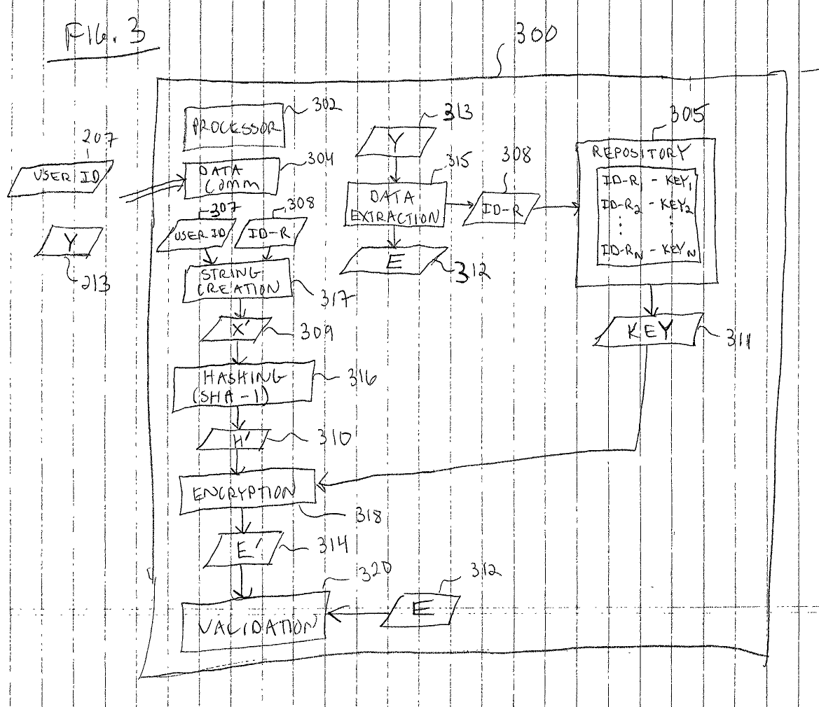

FIG. 3 is a schematic block diagram of an example PAM 300 suitable for use in data communication system 100. In a typical deployment, PAM 300 is realized at the respective web site host, e.g., the server (or servers) that maintains Site B 108. FIG. 3 illustrates certain data elements and functional features of PAM 300 to aid in the following description of the trust establishment protocol carried out between receiver component 200 and PAM 300. Data elements may be stored in and retrieved from any suitable memory element (not shown) such as a magnetic disk, a ROM, or the like. In a practical deployment, the data elements can be stored in and retrieved from memory elements associated with the web site host and/or “remote” memory elements with which the web site host communicates. Functional elements shown in FIG. 3 may be realized in any number of computer program instructions, in firmware, in hardware, or in any combination thereof.

PAM 300 generally includes a processor 302 and a data communication element 304. Processor 302 is suitably configured to carry out the techniques, protocols, and software instructions described herein. In a system where the PAM and the receiver component are both implemented in connection with one web site (e.g., Site B 108), processor 302 (or portions thereof) and processor 202 (or portions thereof) may be realized as one or more shared processors. Data communication element 304, which may include hardware, firmware, and/or software, facilitates the exchange of data, signals, packets, and information between PAM 300 and other components in system 100, e.g., PC 110, EAM system 114, and/or receiver component 200. In the example system described herein, data communication element 304 receives user ID 207 and string 213 from receiver component 200. These two data elements can be included in or otherwise received with a suitable login request generated by receiver component 200.

PAM 300 may include a repository 305 (e.g., a look-up table) containing a number of entries, where each entry includes an identifier and a corresponding shared secret key. Repository 305 may be stored in a suitable memory or storage element associated with PAM 300. In this regard, repository 305 can be stored “locally” at Site B 108 or it can be stored “remotely” such that PAM 300 has access to it via, e.g., data communication element 304. In one practical embodiment, repository 305 is created before the trust establishment protocol is executed between the receiver component and PAM 300. Repository 305 may be updated from time to time to reflect the addition, removal, or modification of entries. In the example embodiment, repository 305 contains a plurality of entries to enable PAM 300 to support a number of applications or application groups, each having a corresponding receiver component and each having a unique receiver identifier (ID-R).

As described in more detail below, PAM 300 may receive, generate, store, retrieve, process, or send the following (and possibly other) items in connection with the trust establishment protocol: a user ID 307 (which may correspond to the received user ID 207), a receiver identifier 308, a string 309, a string 313 (which may correspond to the received string 213), a hash 310, a shared secret key 311, a first encrypted expression 312, and a second encrypted expression 314. PAM 300 performs data extraction 315, performs string creation 317 to form various strings utilized by PAM 300, performs hashing operations 316 on data, performs encryption 318 (using an encryption algorithm and secret key 311) to generate second encrypted expression 314, and performs a validation routine 320 to validate expressions processed by PAM 300. It should be appreciated that the data extraction function 315, the string creation function 317, the hashing function 316, the encryption function 318, and the validation function 320 may each be implemented in software, hardware, firmware, or a combination thereof, and each can be executed or controlled by processor 302 or by any suitable processing element associated with PAM 300. Accordingly, PAM 300 may include a suitably configured data extractor that performs the data extraction function 315, a suitably configured string creator that performs the string creation function 317, a suitably configured hashing element that performs the hashing function 316, a suitably configured encryptor that performs the encryption function 318, and a suitably configured validator that performs the validation function 320. The relevance of these items and features, their characteristics, and the manner in which PAM 300 interacts with receiver component 200 are discussed below.

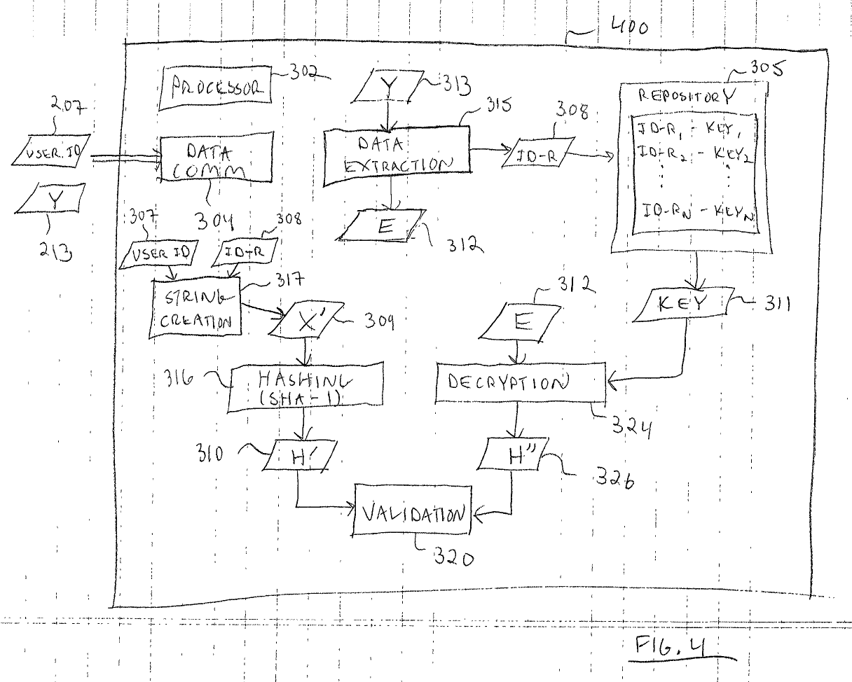

FIG. 4 is a schematic block diagram of an alternate PAM 400 suitable for use with system 100. PAM 400 and PAM 300 share many features and functions; the following description of PAM 400 focuses on the differences between PAM 300 and PAM 400. In practice, a single PAM may be configured in accordance with both PAM 300 and PAM 400 to enable the PAM to perform different variations of the trust establishment protocol. Notably, in addition to the data elements described above in connection with PAM 300, PAM 400 may receive, generate, store, retrieve, process, or send a decrypted expression 326 in connection with the trust establishment protocol. In the example embodiment, decrypted expression 326 represents a hash value (H″). Furthermore, PAM 400 performs decryption 324 (using an encryption algorithm and secret key 311) to generate decrypted expression 326. As mentioned above, decryption function 324 can be implemented in software, hardware, firmware, or a combination thereof, and it can be executed or controlled by processor 302 or by any suitable processing element associated with PAM 400. Accordingly, PAM 400 may include a suitably configured decryptor that performs the decryption function 324. The relevance of these items and features, their characteristics, and the manner in which PAM 400 interacts with receiver component 200 are discussed below.

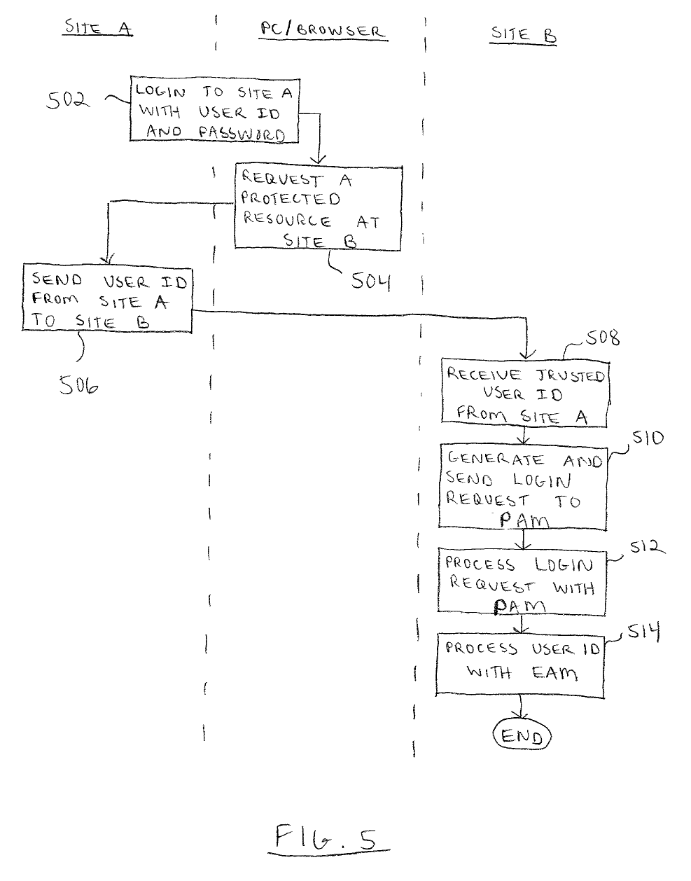

FIG. 5 is a flow diagram that represents a typical single sign-on procedure that incorporates the techniques of the present invention. Data communication system 100 (see FIG. 1) is capable of supporting such a procedure. The single sign-on procedure reflects one practical scenario that calls for the trust establishment protocol between receiver component 104 and PAM 116. In this example, an end user has access to Site A 106 and to Site B 108 via web browser 112 installed on the end user PC 110. In a practical implementation, the web browser 112 can be a conventional off-the-shelf web browser product such as Microsoft's INTERNET EXPLORER.

The example single sign-on process assumes that the user has already performed an appropriate login at Site A 106 (task 502). In accordance with conventional authentication techniques, task 502 prompts the user to enter a user ID (i.e., a username) and a password to gain access to Site A 106 (or to gain access to restricted or protected resources maintained at Site A 106). In this regard, Site A 106 may employ a conventional EAM system to facilitate end user authentication. Eventually, the user requests access to Site B 108 or requests a protected or restricted resource located at Site B 108 (task 504). In practice, task 504 may be performed in response to the selection of a suitable link displayed on a web page of Site A 106. In response to the user request, Site A 106 initiates a handshake protocol with Site B. During this handshake protocol, the user ID is sent from Site A 106 to Site B 108 (task 506). Typically, the user ID sent during task 506 is the same user ID received by Site A 106 during the initial login procedure (see task 502). In the practical embodiment described herein, Site A 106 need not send a user password corresponding to the user ID to Site B 108.

In the preferred embodiment, task 506 sends the user ID in a secure manner such that Site B 108 can presume that it has received a trusted user ID from Site A 106 (task 508). Thus, Site B 108 can assume that the user has been previously authenticated by another system or application. During task 508, receiver component 104 receives the user ID, which may be recognizable by EAM system 114. In other words, the user ID can be processed by EAM system 114 for purposes of performing authentication, authorization, access rights allocation, or other access management actions. Alternatively, the received user ID (utilized for authentication by Site A 106) may correspond to a different user ID associated with Site B 108. For example, at Site A 106, a user can be identified by the ID “usernameA” and, at Site B 108, the same user can be identified by the ID “usernameB”. The user will login to Site A 106 with “usernameA”, and “usernameA” will be securely transferred to Site B 108 during the handshake protocol. Thereafter, receiver component 104 may consult a mapping table (not shown) to determine the correct user ID (for Site B 108) corresponding to “usernameA”. In this example, the receiver component 104 will retrieve “usernameB” and handle it as described below.

As used herein, a trusted user ID refers to a user ID that has been previously authenticated and/or is otherwise acknowledged as being a valid and legitimate user ID. Thus, the received user ID represents a user authenticated by a system or process that is independent of EAM system 114. In accordance with one practical embodiment, the handshake protocol is designed such that Site B 108 can confirm that the received user ID could only have originated from Site A 106 and that the received user ID was not modified in transit from Site A 106 to Site B 108. A suitable handshake protocol is described in U.S. patent application Ser. No. ______, entitled “Challenge-Response Data Communication Protocol,” the contents of which are hereby incorporated by reference.

Eventually, receiver component 104 generates and sends a login request that is eventually directed to PAM 116 (task 510). In the example embodiment, the login request is based upon a user ID, and the login request is generated and configured in accordance with the trust establishment protocol described below. Notably, the login request is void of a user password corresponding to the user ID. In other words, unlike the original authentication performed at Site A 106, PAM 116 need not process the end user password. This feature enables Site B 108 (and EAM system 114 in particular) to perform authentication functions without having to securely store or maintain a list of current end user passwords.

PAM 116 receives the login request and evaluates and processes the login request (task 512) in accordance with the trust establishment protocol described below. During task 512, PAM 116 determines whether the login request was generated and/or sent by a trusted and legitimate source (e.g., receiver component 104). In the absence of such a trust establishment mechanism between receiver component 104 and PAM 116, an unscrupulous user or program could point a browser application to PAM 116 and ask to be logged in by sending any arbitrary user ID as part of an illegitimate login request. In accordance with conventional software interfacing techniques, the user ID may be forwarded to EAM system 114 for further processing (task 514). During task 514, EAM system 114 may perform one or more access management actions, particularly if PAM 116 validates the integrity of the login request and/or the legitimacy of the user ID. For example, EAM system 114 (in conjunction with PAM 116) can process the user ID to ensure that the user ID is defined as a valid user of Site B 108 and that the user ID is marked as “enabled”. For example, if a user is marked as “disabled” for some reason or if the user ID doesn't exist in the user repository at Site B 108, then EAM system 114 or PAM 116 can return an error code indicating a login failure.

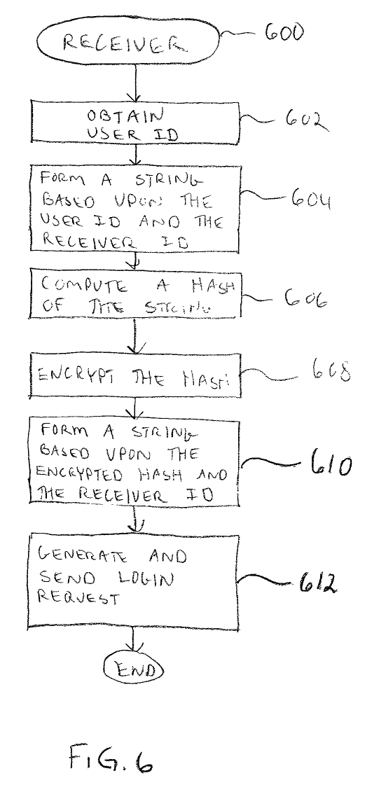

FIG. 6 is a flow diagram representing a portion of a trust establishment protocol performed by a receiver component such as receiver component 200 (see FIG. 2). The receiver process 600 shown in FIG. 6 can be performed by any receiver component configured to communicate with a compatible PAM (e.g., PAM 300 or PAM 400), regardless of the manner in which such components are actually implemented. Generally, the trust establishment protocol is conducted to transfer a user ID from the receiver component to the PAM in a manner that establishes that the receiver component (or the login request generated by the receiver component) is legitimate and trustworthy.

For purposes of this example, the receiver component and the corresponding PAM have prior knowledge of a shared secret key, which may be encrypted or otherwise stored in a secure manner. In a practical embodiment, the shared secret key is unique to the receiver-PAM combination and one PAM may be configured to communicate with a plurality of different receiver components (each having a different secret key shared with the PAM). In addition, each unique receiver component may utilize a different receiver identifier that identifies the particular receiver component (and/or identifies the secret key used by that receiver component) to the PAM. As described in connection with FIG. 3, the PAM may utilize a repository that contains a list of different keys and the corresponding receiver identifiers. In FIG. 2, key 211 represents the shared secret key; in FIG. 3, key 311 represents the shared secret key. In the practical embodiment, the secret key is realized as an alphanumeric string.

The trust establishment protocol begins when the receiver component obtains a user ID (task 602) from, e.g., a sender component (see FIG. 1). As described above, the receiver component can assume that the received user ID is trustworthy and that it represents a previously authenticated user. In practice, the user ID may be received in connection with a request for a protected resource accessible via the PAM. Next, the receiver component forms a string, e.g., string 209, based upon a user ID and the receiver identifier corresponding to the receiver component (task 604). The user ID processed during task 604 may be the same user ID received from the sender component or a different user ID that is mapped to the received user ID. The string can be an alphanumeric expression or any suitably configured parameter. In accordance with one practical embodiment, this string is created by combining the user ID with the receiver identifier to form a single parameter. For example, the string can be formed by concatenating the user ID and the receiver identifier to form a single alphanumeric expression: X=U+R, where X represents the string, U represents the user ID, and R represents the receiver identifier. Of course, this string can be formed by concatenating the user ID and the receiver identifier in reverse order, or by combining the user ID and the receiver identifier in accordance with any suitable algorithm, formula, or scheme.

The receiver component computes a hash (see hash 210 shown in FIG. 2) of the string (task 606) created in task 604. In this regard, the resulting hash is associated with and based upon the user ID and the receiver identifier. The receiver component performs a suitable hashing operation during task 606 to generate a unique hash value corresponding to each unique string. In other words, no two strings will result in the same hash value. For example, the receiver component may perform a one-way hashing operation on the string to obtain the hash. A one-way hashing operation ensures that, knowing only the hash, it is nearly impossible to derive the string. A one-way hashing operation also ensures that only one possible input string can lead to the same hash. In accordance with the currently preferred embodiment, the receiver component employs the SHA-1 hashing algorithm to generate the string: H=SHA-1 [X], where H represents the hash value. The SHA-1 hashing algorithm, which is virtually an industry standard, is considered to be one of the strongest hashing algorithms currently available. In accordance with the SHA-1 hashing algorithm, the hash value is configured as a string of 40 alphanumeric characters. Alternate embodiments may utilize different operations or algorithms to generate hash values having different characteristics (preferably maintaining the characteristics of a one-way hashing operation). For example, the MD-5 hashing algorithm can be used instead of the SHA-1 hashing algorithm.

The hash value is then encrypted to create an encrypted expression (task 608). Notably, the encrypted expression is based upon the user ID obtained in task 602. Task 608 employs a suitable encryption algorithm and the shared secret key to generate the encrypted expression: E=Encryptₛ[H], where E represents the encrypted expression (see FIG. 2, which shows encrypted expression 212). The preferred embodiment utilizes a symmetric encryption algorithm that supports decryption with the same secret key. Known or proprietary encryption algorithms can be used during task 608. One practical embodiment of the present invention utilizes the symmetric encryption algorithm known as Twofish. Other symmetric-key algorithms are also available for use in this context, e.g., DES, Triple-DES, and the like. The encrypted expression is formatted as an alphanumeric string. Although the encryption algorithm may generate a non-alphanumeric string, a corresponding alphanumeric string can be obtained by converting each character in the encrypted result into the corresponding hexadecimal representation. Similarly, from the alphanumeric representation of a string, it is always possible to obtain the alternate form by converting each alphanumeric character or group of characters back to the non-alphanumeric equivalent.

Next, the receiver component forms a string, e.g., string 213, based upon the encrypted expression generated during task 608 and the receiver identifier (task 610). The string can be an alphanumeric expression or any suitably configured parameter. In accordance with one practical embodiment, this string is created by combining the encrypted expression with the receiver identifier to form a single parameter. For example, the string can be formed by concatenating the receiver identifier, at least one separation character (e.g., a hyphen, a slash, or the like), and the encrypted expression to form a single alphanumeric expression: Y=R+“−”+E, where Y represents the string, R represents the receiver identifier, and E represents the encrypted expression. Of course, this string can be formed by concatenating the encrypted expression and the receiver identifier in reverse order, or by combining the encrypted expression and the receiver identifier in accordance with any suitable algorithm, formula, or scheme.

Next, the receiver component generates a suitable login request and sends the login request, which is ultimately received by the PAM (task 612). In accordance with one practical embodiment, the login request includes the user ID processed during task 604 (i.e., the user ID recognized by the EAM system, which may either be the same user ID received from the sender component or a user ID corresponding to the user ID received from the sender component) and the string (Y) created during task 610. For compatibility with many existing EAM systems, login requests are usually formatted to contain only two parameters. With respect to conventional PAMs, these two parameters correspond to the user ID and password. In contrast, with respect to the example described herein, these two parameters correspond to the user ID and a suitably formatted string. Notably, the login request sent during task 612 is intentionally void of a user password corresponding to the user ID. The combined nature of the string allows the trust establishment protocol to effectively transport two parameters (the encrypted expression and the receiver identifier) in the “space” allocated for one parameter.

Once the login request has been sent, the receiver component need not engage in ongoing communications or data exchanges with the PAM while the login request is being validated by the PAM. In a practical embodiment, the receiver component may wait for a response from the EAM system, e.g., “login success” or “login failure”. However, the receiver component need not play an active role in the validation of the login request. Consequently, receiver process 600 ends after task 612 sends the login request to the PAM. At this point, the PAM carries out the remainder of the trust establishment protocol.

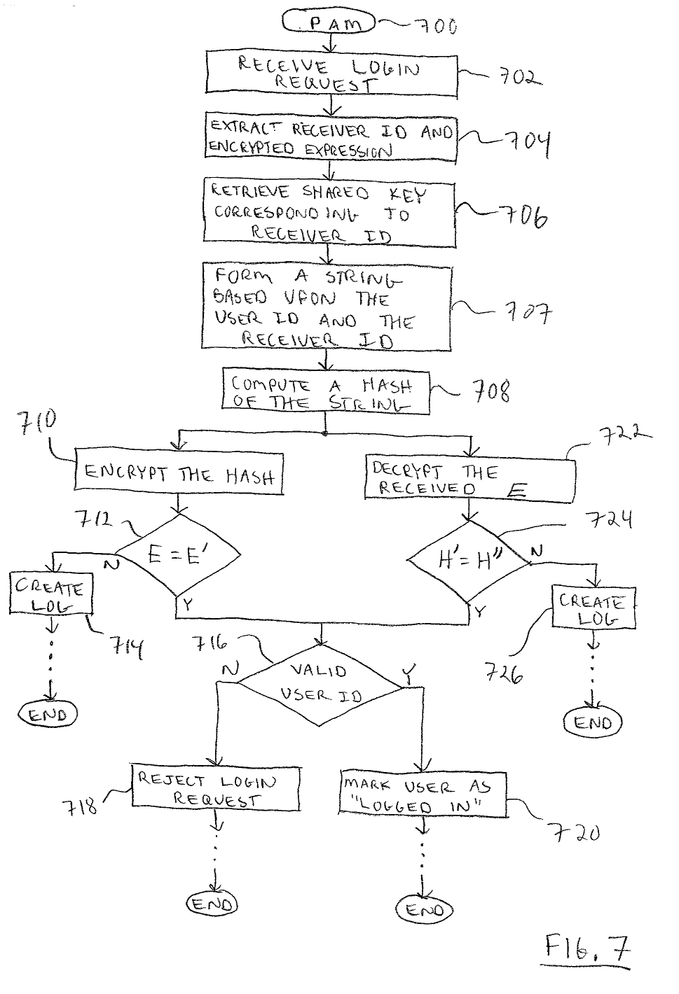

FIG. 7 is a flow diagram representing the portion of the example trust establishment protocol performed by the PAM. FIG. 3 and FIG. 4 depict PAMs configured to perform the PAM process 700. The PAM process 700 begins when the PAM receives a login request (task 702). For purposes of this example, the login request contains the string (Y) and the user ID processed by the receiver component. The PAM obtains the string and extracts the receiver ID and the encrypted expression from the string (task 704). As described above, the string may be formatted in a particular manner that allows receiver ID and the encrypted expression to be easily distinguished and extracted.

The extracted receiver ID is then used to retrieve the secret key shared between the receiver component and the PAM (task 706). As described above in connection with FIG. 4, the PAM may interrogate its key repository to determine which key corresponds to the extracted receiver ID. The key is eventually used to encrypt/decrypt data using the same encryption algorithm used by the receiver component. The extracted receiver ID and the received user ID are used to form a string (task 707). In the preferred embodiment, this string is created by concatenating the user ID and the receiver identifier to form a single alphanumeric expression: X′=U+R, where X′ represents the string, U represents the user ID, and R represents the receiver identifier. Of course, this string can be formed by concatenating the user ID and the receiver identifier in reverse order, or by combining the user ID and the receiver identifier in accordance with any suitable algorithm, formula, or scheme.

The newly-created string is used to generate a hash (H′) (task 708). Task 708 utilizes the same hashing algorithm used by the receiver component; in this example, the SHA-1 hashing algorithm is used. Thus, assuming that the received string was not modified or corrupted while being transferred to the PAM, task 708 will generate the same hash value that was produced by task 606 (described above).

If the PAM is configured like PAM 300, then the hash value (H′) is encrypted using an encryption algorithm and the retrieved key (task 710). Task 710 employs the same encryption algorithm used by the receiver component during task 608. Task 710 results in the creation of an encrypted expression (E′). This newly created encrypted expression is compared to the encrypted expression (E), which was extracted from the received string (Y) (query task 712). In this respect, the PAM validates the newly created encrypted expression. If the two values match, then the PAM treats the login request as legitimate and validates the login request in an appropriate manner. On the other hand, if the two values do not match, then the event may be marked by creating a suitable log entry (task 714) before terminating the PAM process 700; the PAM may return an appropriate code to the EAM system at this point. Thus, PAM process 700 evaluates the login request to determine whether it was generated by a trusted source, e.g., a legitimate receiver component.

Even if the login request has been validated, the EAM system may first perform one or more access management actions before providing access to the end user. For example, the EAM system may determine whether the user ID represents a valid and currently enabled user (query task 716). The determination of a valid and enabled user ID is specific to the particular EAM product utilized by Site B. If the user ID is no longer valid, then the PAM and/or the EAM system will reject the login request (task 718) and deny access to the end user. However, if the user ID is valid, then the PAM and/or the EAM system will proceed to mark the end user as “logged in” (task 720) and provide access to the requested resource. The EAM system may perform additional or alternative access management actions such as the processing and return of cookies to the receiver component (the receiver component can thereafter send the cookies back to the end user's web browser).

If the PAM is configured like PAM 400, then the encrypted expression (E), which was extracted from the received string (Y), is decrypted (task 722) using an encryption algorithm and the retrieved key. Task 722 employs a symmetric encryption algorithm, which is also used by the receiver component during task 608. The symmetric nature of the encryption algorithm makes it possible to use the same key to encrypt and decrypt a data element. Task 722 results in a decrypted expression (H″) that corresponds to a hash value. Theoretically, if the login request is legitimate, then the decrypted hash value will match both the hash value (H′) created during task 708 and the original hash value (H) calculated by the receiver component during task 606.

The newly created hash value (H″) is compared to the hash value (H′) created during task 708 (query task 724). In this respect, the PAM validates the newly created hash value. If the two values match, then the PAM treats the login request as legitimate and validates the login request in an appropriate manner. On the other hand, if the two values do not match, then the event may be marked by creating a suitable log entry (task 726) before terminating the PAM process 700. Thus, PAM process can employ this alternate scheme to evaluate the login request and to determine whether it was generated by a trusted source, e.g., a legitimate receiver component. Of course, a practical PAM embodiment can be configured to optionally perform either of the validation routines described herein.

The trust establishment protocol, which preferably includes receiver process 600 and PAM process 700, facilitates authentication by a PAM using only a trusted user ID and without having to store, access, or process user passwords. The trust establishment protocol is particularly desirable when utilized in conjunction with an off-the-shelf EAM product that has a PAM interface. A PAM configured in accordance with the present invention can be “plugged” directly into an existing EAM product, and a receiver component configured in accordance with the present invention can be loaded onto the same host server or servers that protect the restricted resources. The PAM and the receiver component are compatible with each other such that the PAM can determine whether to trust a login request that is void of a user password. In accordance with one practical application, the receiver component, the PAM, and the techniques of the present invention provide an effective and easily deployable single sign-on solution.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A user authentication method comprising:
obtaining a user identification (ID) recognizable by an enterprise access management (EAM) system;
generating a login request based upon said user ID, said login request being void of a user password corresponding to said user ID; and
evaluating said login request with a processing module compatible with said EAM system.

2. A method according to claim 1, wherein said evaluating step comprises determining whether said login request was generated by a trusted source.

3. A method according to claim 1, wherein said evaluating step comprises validating said user ID.

4. A method according to claim 3, further comprising said EAM system performing an access management action if said validating step validates said user ID.

5. A method according to claim 1, wherein said user ID represents a user authenticated by a system independent of said EAM system.

6. A user authentication method comprising:
obtaining a user identification (ID) recognizable by an enterprise access management (EAM) system;
creating an encrypted expression based upon said user ID; and
sending said encrypted expression to a processing module compatible with said EAM system.

7. A method according to claim 6, further comprising generating a login request that includes said encrypted expression.

8. A method according to claim 7, wherein said encrypted expression is sent to said processing module with said login request.

9. A method according to claim 7, wherein said login request is void of a user password corresponding to said user ID.

10. A method according to claim 6, wherein said creating step encrypts a hash to create said encrypted expression.

11. A method according to claim 10, further comprising performing a hashing operation on a string to compute said hash, wherein said string is based upon said user ID.

12. A user authentication method comprising:
receiving a login request at a processing module compatible with an enterprise access management (EAM) system, said login request including a user identification (ID) recognizable by said EAM system, and said login request being void of a user password corresponding to said user ID; and
said processing module evaluating said login request to determine whether said login request was generated by a trusted source.

13. A method according to claim 12, further comprising generating a parameter based upon user ID.

14. A method according to claim 13, further comprising performing a hashing operation on said parameter to compute a hash.

15. A method according to claim 14, further comprising:
encrypting said hash to create a first encrypted expression;
extracting a second encrypted expression from said parameter; and
comparing said first encrypted expression to said second encrypted expression.

16. A method according to claim 15, further comprising validating said login request if said comparing step results in a match between said first encrypted expression and said second encrypted expression.

17. A method according to claim 16, further comprising said EAM system performing an access management action if said validating step validates said login request.

18. A method according to claim 14, further comprising:
extracting an encrypted expression from said parameter;
decrypting said encrypted expression to obtain a second hash; and
comparing said hash to said second hash.

19. A method according to claim 18, further comprising validating said login request if said comparing step results in a match between said hash and said second hash.

20. A method according to claim 19, further comprising said EAM system performing an access management action if said validating step validates said user ID.

21. A user authentication method comprising:
obtaining a user identification (ID) recognizable by an enterprise access management (EAM) system;
forming a string based upon said user ID and an identifier;
performing a hashing operation on said string to compute a hash;
encrypting said hash, with an encryption algorithm that utilizes a key corresponding to said identifier, to create an encrypted expression; and
generating a login request that includes said user ID and a parameter derived from said encrypted expression, said login request being void of a user password corresponding to said user ID.

22. A method according to claim 21, wherein said encrypting step utilizes a symmetric encryption algorithm.

23. A method according to claim 21, wherein said string is formed as a concatenation of said user ID and said identifier.

24. A method according to claim 21, further comprising receiving said login request at a processing module compatible with said EAM system.

25. A method according to claim 24, further comprising said processing module:
generating said string from parameters included with said login request; and
performing said hashing operation on said string to compute a second hash.

26. A method according to claim 25, further comprising said processing module:
extracting said identifier from said login request;
retrieving a stored key corresponding to said identifier; and
encrypting said second hash, with an encryption algorithm that utilizes said stored key, to create a second encrypted expression.

27. A method according to claim 26, further comprising said processing module:
extracting said encrypted expression from said login request;
comparing said encrypted expression to said second encrypted expression; and
validating said login request if said comparing step results in a match between said first encrypted expression and said second encrypted expression.

28. A method according to claim 25, further comprising said processing module:
extracting said identifier and said encrypted expression from said login request;
retrieving a stored key corresponding to said identifier; and
decrypting said encrypted expression, with a decryption algorithm that utilizes said stored key, to obtain a decrypted expression.

29. A method according to claim 28, further comprising said processing module:
comparing said second hash to said decrypted expression; and
validating said login request if said comparing step results in a match between said second hash and said decrypted expression.

30. A computer program embodied on a computer-readable medium, said computer program having computer-executable instructions for carrying out a method comprising:
obtaining a user identification (ID) recognizable by an enterprise access management (EAM) system;
creating an encrypted expression based upon said user ID; and
sending said encrypted expression to a processing module compatible with said EAM system.

31. A computer program embodied on a computer-readable medium, said computer program having computer-executable instructions for carrying out a method at a processing module compatible with an enterprise access management (EAM) system, said method comprising:
receiving a login request including a user identification (ID) recognizable by said EAM system, said login request being void of a user password corresponding to said user ID; and
evaluating said login request to determine whether said login request was generated by a trusted source.
